(19) United States
(12) Patent Application Publication
(10) Pub. No.: US 2014/0297253 A1
(43) Pub. Date: Oct. 2, 2014

(54) TRANSLATION SUPPORT APPARATUS, TRANSLATION SUPPORT SYSTEM, AND TRANSLATION SUPPORT PROGRAM

(71) Applicant: FUJITSU LIMITED, Kawasaki-shi (JP)

(72) Inventors: Tomoki Nagase, Kawasaki (JP); Masaru FUJI, Musashino (JP)

(73) Assignee: FUJITSU LIMITED, Kawasaki-shi (JP)

(21) Appl. No.: 14/180,557

(22) Filed: Feb. 14, 2014

(30) Foreign Application Priority Data
Mar. 28, 2013 (JP) 2013-070683

(51) Int. Cl. G06F 17/28

(52) U.S. Cl. CPC G06F 17/289
USPC 704/2

(57) ABSTRACT

A translation support apparatus according to an embodiment applies a bottom-up syntax analysis rule to original information and translation information to generate subtrees corresponding to the combinations of all the character strings and makes the subtrees of the original and the translation correspond to each other. Then, for each pair of the subtrees of the original and the translation, the translation support apparatus evaluates a correspondence degree according to the presence or absence of the relevance between words based on a bilingual dictionary and the proximity of the number of the constituting words.

### CROSS-REFERENCE TO RELATED APPLICATION

This application is based upon and claims the benefit of priority of the prior Japanese Patent Application No. 2013-070683, filed on Mar. 28, 2013, the entire contents of which are incorporated herein by reference.

### FIELD

The embodiment discussed herein is directed to a translation support apparatus and the like.

### BACKGROUND

As translation support technologies for supporting translators, there have been proposed so-called a number of sentence proofreading technologies such as technologies for supporting the selection of appropriate translated words and technologies for checking inappropriate terms fluctuating in their expressions. For sentence proofreading, it is troublesome to find out “translation missing” in translation operations. Therefore, it has been demanded to establish efficient methods for preventing or detecting translation missing.

For example, in Japanese Laid-open Patent Publication No. 5-298360, a human-generated translation is compared with a machine-generated translation, and the sameness in the meaning between sentences is determined according to a proportion with which common translation words are contained, or the like. Further, in Japanese Laid-open Patent Publication No. 5-298360, when there are some untranslated sentences due to users' carelessness, the untranslated sentences are notified.

In Japanese Laid-open Patent Publication No. 2004-310170, when the sentences of two corresponding languages are given, syntax analysis is performed on the respective languages to extract the candidates of corresponding phrases. For example, based on Japanese Laid-open Patent Publication No. 2004-310170, it is possible to check the correspondences of the constituting words between respective candidates to specify translation missing candidates. These related-art examples are described, for example, Patent Literature 3: Japanese Laid-open Patent Publication No. 2010-27020.

However, according to the technologies described above, it is difficult to detect translation missing candidates.

For example, according to Japanese Laid-open Patent Publication No. 5-298360, it is possible to presume “sentences” not found in translation results but is not possible to respond to general translation missing detection in which words and phrases not translated from an original are specified.

In addition, Japanese Laid-open Patent Publication No. 2004-310170, evaluates correspondences using phrases contained in the results of the syntax analysis of first and second languages as candidates. And, for patent specifications containing long and complicated sentences and novels containing distinctive expressions, there is a likelihood that syntax analysis is not successfully performed, and thus it is not possible to specify translation missing candidates.

### SUMMARY

According to an aspect of an embodiment, a translation support apparatus includes a memory; and a processor coupled to the memory, wherein the processor executes a process comprising: generating a plurality of first subtrees and a plurality of second subtrees, by applying a bottom-up syntax analysis rule to an original and a translation, the first subtrees forming combinations of respective character strings contained in the original to constitute phrases, the second subtrees forming combinations of respective character strings contained in the translation to constitute phrases; making the plurality of first and second subtrees correspond to each other; and evaluating for each pair of the corresponding first and second subtrees a correspondence degree according to presence or absence of relevance between words based on a bilingual dictionary and proximity of the number of the constituting words.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a function block diagram illustrating the configuration of a translation support apparatus according to an embodiment;

FIG. 2 is a diagram illustrating an example of original information;

FIG. 3 is a diagram (1) illustrating an example of translation information;

FIG. 4 is a diagram (2) illustrating an example of the translation information;

FIG. 5 is a diagram illustrating an example of a word correspondence table;

FIG. 6 is a diagram illustrating an example of subtree information;

FIG. 7 is a diagram for describing the start position and the word length of the subtree information;

FIG. 8 is a diagram (1) illustrating an example of a correspondence table;

FIG. 9 is a diagram (2) illustrating an example of the correspondence table;

FIG. 10 is a diagram (3) illustrating an example of the correspondence table;

FIG. 11 is a diagram illustrating an example of translation missing candidate information;

FIG. 12 is a diagram illustrating an example of an original morpheme list;

FIG. 13 is a diagram illustrating an example of a translation morpheme list;

FIG. 14 is a diagram for describing processing results by a word correspondence analysis unit;

FIG. 15 is a diagram (1) illustrating an example of processing results with the application of a bottom-up syntax analysis rule;

FIG. 16 is a diagram (2) illustrating an example of processing results with the application of the bottom-up syntax analysis rule;

FIG. 17 is a diagram for describing the processing of an evaluation unit;

FIG. 18 is a diagram (1) illustrating an example of a display screen;

FIG. 19 is a diagram (2) illustrating an example of the display screen;

FIG. 20 is a flowchart illustrating the processing procedure of the translation support apparatus according to the embodiment;

FIG. 21 is a flowchart illustrating the processing procedure of phrase correspondence analysis;

FIG. 22 is a flowchart illustrating the processing procedure of translation missing candidate presumption;

FIG. 23 is a flowchart (1) illustrating a processing procedure for generating the word correspondence table;

FIG. 24 is a flowchart (2) illustrating a processing procedure for generating the word correspondence table; and

FIG. 25 is a diagram illustrating an example of a computer that performs a translation support program.

### DESCRIPTION OF EMBODIMENT

Preferred embodiments of the present invention will be explained with reference to accompanying drawings. Note that the invention is not limited to the embodiment.

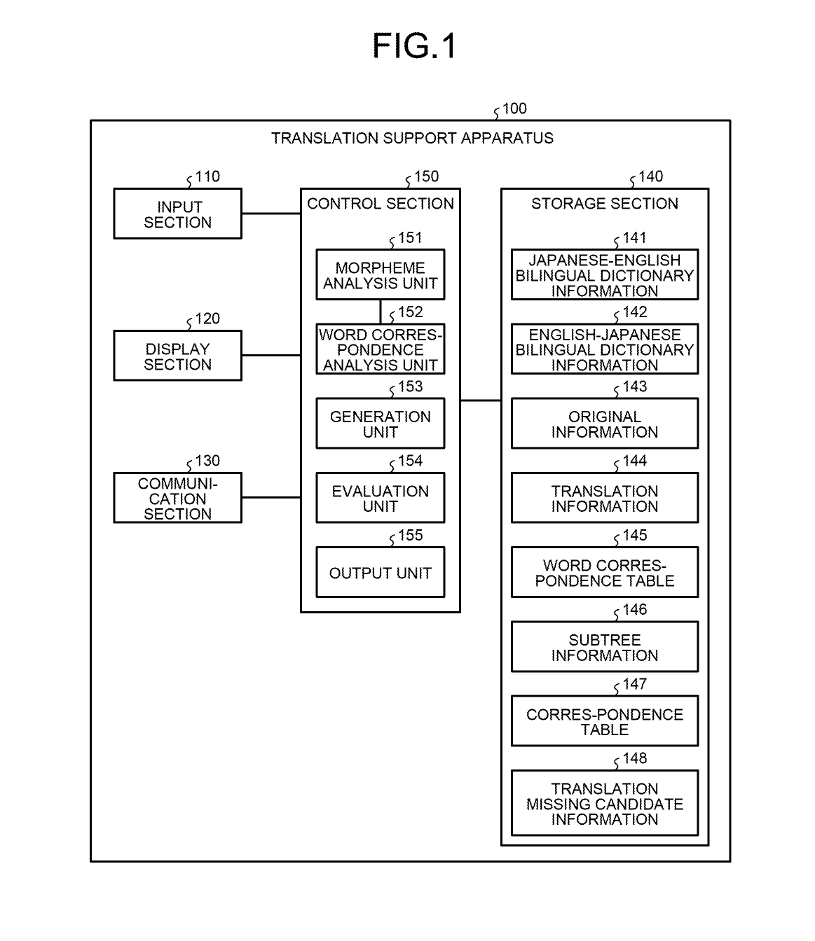

A description will be given of the configuration of the translation support apparatus according to the embodiment. FIG. 1 is a function block diagram illustrating the configuration of the translation support apparatus according to the embodiment. As illustrated in FIG. 1, a translation support apparatus 100 has an input section 110, a display section 120, a communication section 130, a storage section 140, and a control section 150.

The input section 110 is an input device used to input various information to the translation support apparatus. For example, the input section 110 corresponds to a keyboard, a mouse, a touch panel, or the like. For example, a user may input original information, translation information, or the like by operating the input section 110.

The display section 120 is a display device used to display various information. For example, the display section 120 corresponds to a liquid crystal display, a touch panel, or the like. The display section 120 displays information output from the control section 150 that will be described later.

The communication section 130 is a processing device used to communicate with other external devices via a network. For example, the communication section 130 corresponds to a communication device or the like.

The storage section 140 has Japanese-English bilingual dictionary information 141, English-Japanese bilingual dictionary information 142, original information 143, translation information 144, a word correspondence table 145, subtree information 146, a correspondence table 147, and translation missing candidate information 148. For example, the storage section 140 corresponds to a storage device such as a RAM (Random Access Memory), a ROM (Read Only Memory), and a semiconductor memory device such as a flash memory.

The Japanese-English bilingual dictionary information 141 is dictionary information in which Japanese words and a plurality of types of English words corresponding to the Japanese words are made to correspond to each other.

The English-Japanese bilingual dictionary information 142 is dictionary information in which English words and a plurality of types of Japanese words corresponding to the English words are made to correspond to each other.

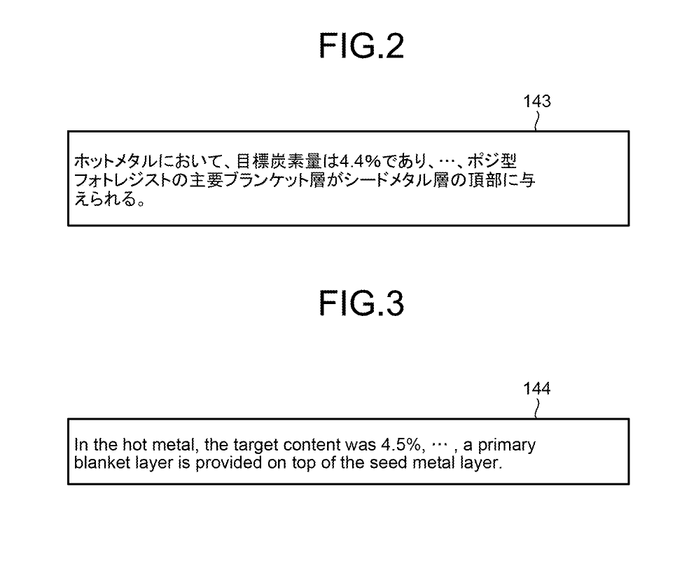

The original information 143 is information on an original to be translated. FIG. 2 is a diagram illustrating an example of the original information.

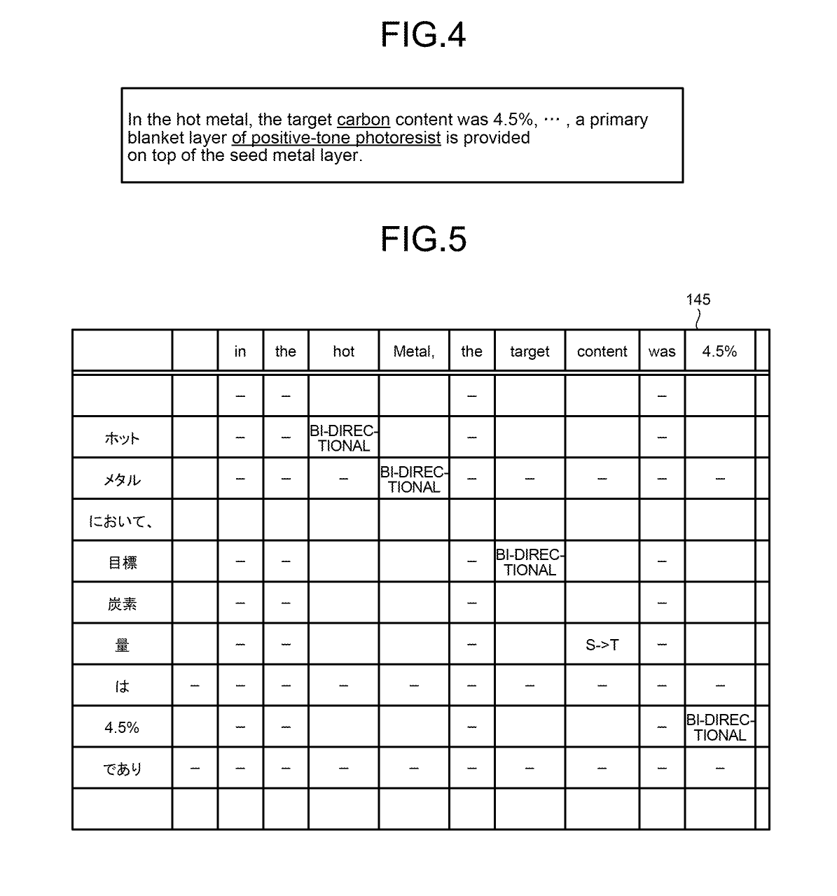

The translation information 144 is information on a translation generated when the user translates an original corresponding to the original information 143. FIGS. 3 and 4 are diagrams each illustrating an example of the translation information. FIG. 3 illustrates the translation information having a translation missing part, and FIG. 4 illustrates the translation information having no translation missing part. The embodiment describes as an example the translation information having a translation missing part illustrated in FIG. 3.

The word correspondence table 145 is information indicating the correspondences between words contained in an original and words contained in a translation based on the Japanese-English bilingual dictionary information 141 and the English-Japanese bilingual dictionary information 142. FIG. 5 is a diagram illustrating an example of the word correspondence table. For example, the correspondences between words contained in an original and words contained in a translation are indicated as any of “bi-directional,” “S→T,” “T→S,” “part of S,” “part of T,” and “no correspondence.”

The correspondence “bi-directional” indicates that the whole original word and the whole translation word are made to correspond to each other by the Japanese-English bilingual dictionary information 141 and the English-Japanese bilingual dictionary information 142. For example, the original word “ [symbol] ” is translated into the word “hot” based on the Japanese-English bilingual dictionary information 141. On the other hand, the translation word “hot” is translated into “ [symbol] ” based on the English-Japanese bilingual dictionary information 142. In this case, the correspondence between the original word “ [symbol] ” and the translation word “hot” is indicated as “bi-directional.”

The correspondence “S→T” indicates that the whole translation word is made to correspond to the whole original word by the Japanese-English bilingual dictionary information 141 but the whole original word is not made to correspond to the whole translation word by the English-Japanese bilingual dictionary information 142. For example, the original word “ [symbol] ” is translated into the word “content” based on the Japanese-English bilingual dictionary information 141. However, it is presumed that the word “content” is not translated into the word “ [symbol] ” based on the English-Japanese bilingual dictionary information 142. In this case, the correspondence between the original word “ [symbol] ” and the translation word “content” is indicated as “S→T.”

The correspondence “T→S” indicates that the whole translation word is not made to correspond to the whole original word by the Japanese-English bilingual dictionary information 141 but the whole translation word is made to correspond to the whole original word by the English-Japanese bilingual dictionary information 142.

The correspondence “part of S” indicates that an English word translated from an original word based on the Japanese-English bilingual dictionary information 141 partially corresponds to translation words. For example, when the original word “ [symbol] ” is translated into an English word based on the Japanese-English bilingual dictionary information 141, the translated English word “layer” partially corresponds to the translation words “metal layer.” In this case, the correspondence between the original word “ [symbol] ” and the translation words “metal layer” is indicated as “part of S.”

The correspondence “part of T” indicates that a Japanese word translated from an original word based on the English-Japanese bilingual dictionary information 142 partially corresponds to original words. For example, when the translation word “seed” is translated into a Japanese word based on the English-Japanese bilingual dictionary information 142, the translated Japanese word “ [symbol] ” partially corresponds to the translation words “ [symbol] ” In this case, the correspondence between the original word “seed” and the translation words “ [symbol] ” is indicated as “part of T.”

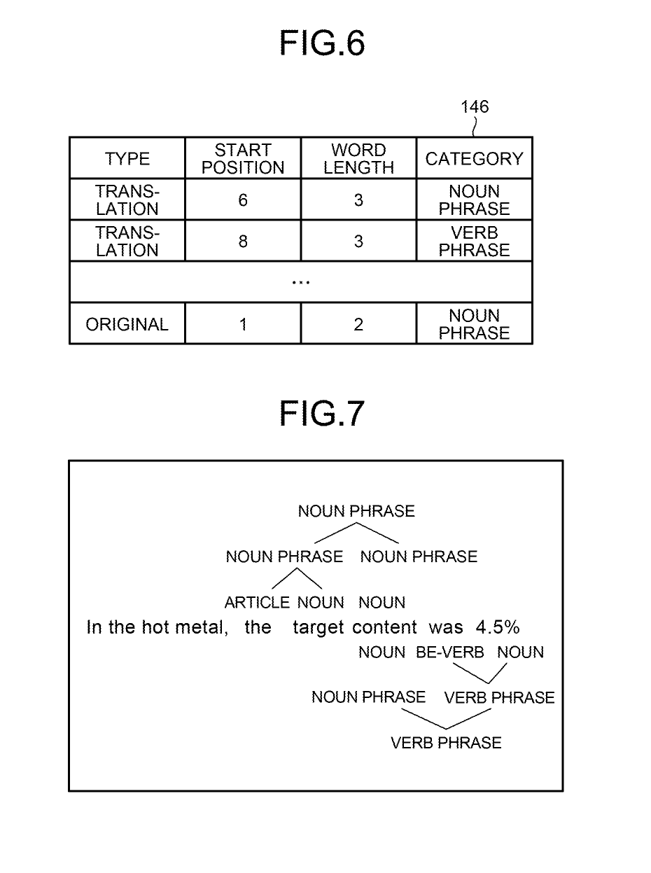

The subtree information 146 contains information on subtrees that form the combinations of respective character strings contained in the original information 143 to constitute phrases. In addition, the subtree information 146 contains information on subtrees that form the combinations of respective character strings contained in the translation information 144 to constitute phrases. FIG. 6 is a diagram illustrating an example of the subtree information. For example, as illustrated in FIG. 6, a type, a start position, a word length, and a category are made to correspond to each other in the subtree information 146. According to the type, the subtrees of the original information 143 and the subtrees of the translation information 144 are distinguished from each other. The start position indicates the start positions of subtrees and is determined based on the number of words from the beginning. The word length indicates the number of words contained in subtrees. The category indicates the types of phases.

FIG. 7 is a diagram for describing the start position and the word length of the subtree information. For example, the subtree corresponding to the start position “6,” the word length “3,” and the category “noun phrase” illustrated in the first row of FIG. 6 indicates the noun phrase “the target content” illustrated in FIG. 7. In addition, the subtree corresponding to the start position “8,” the word length “3,” and the category “verb phrase” illustrated in the second row of FIG. 6 indicates the verb phrase “content was 4.5%” illustrated in FIG. 7.

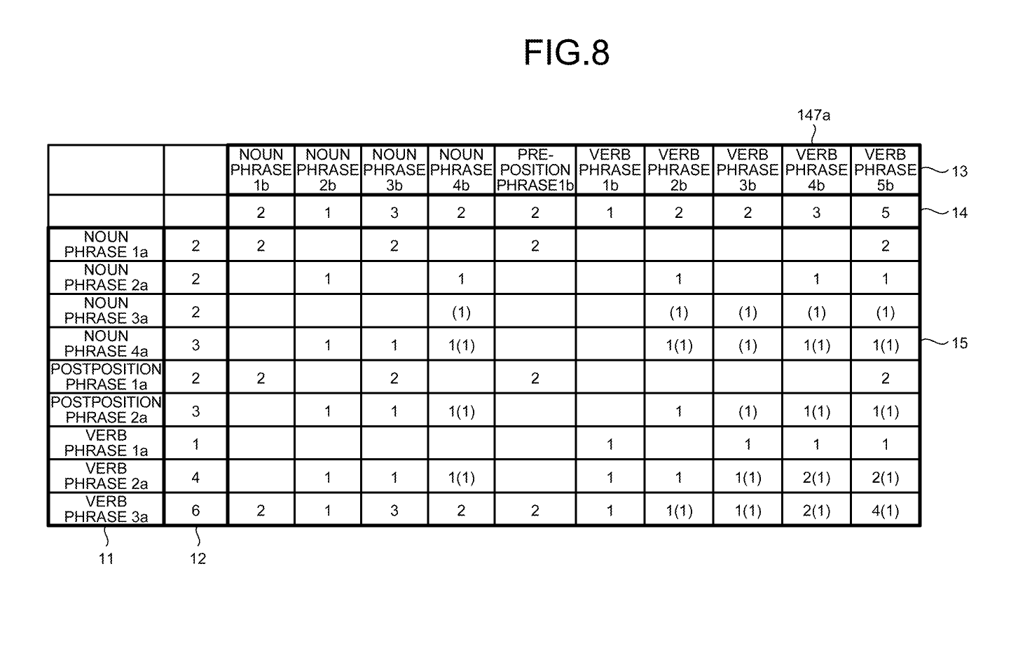

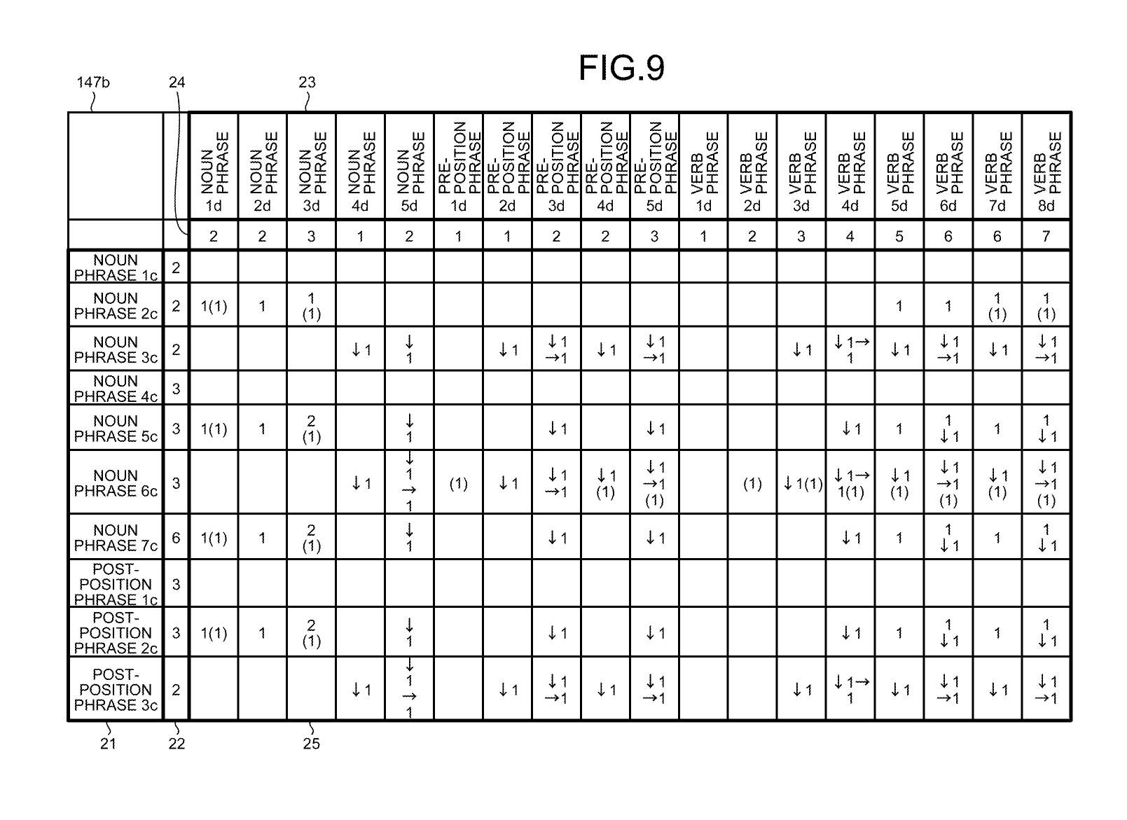

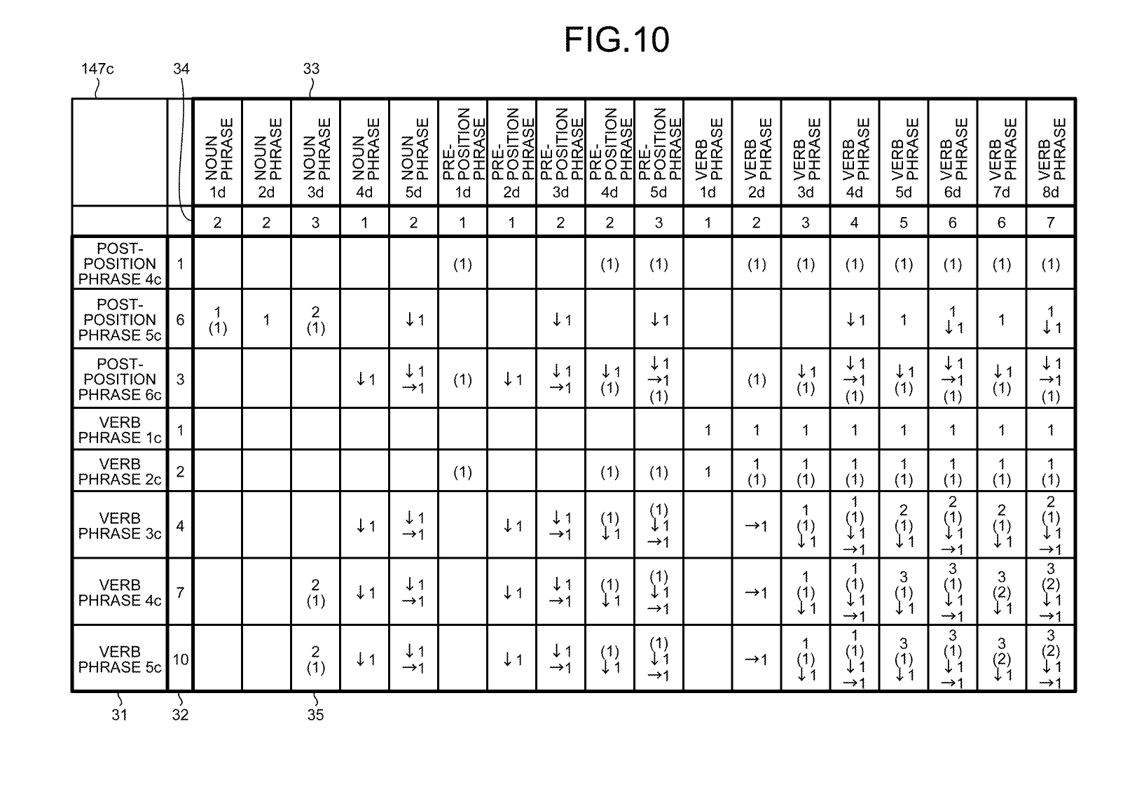

The correspondence table 147 is information indicating the correspondences between phrases contained in an original and phrases contained in a translation. FIGS. 8 to 10 are diagrams each illustrating an example of the correspondence table. For example, the correspondence table 147 includes a correspondence table 147a illustrated in FIG. 8, a correspondence table 147b illustrated in FIG. 9, and a correspondence table 147c illustrated in FIG. 10.

A description will be given of FIG. 8. The correspondence table 147a has regions 11, 12, 13, 14, and 15. The region 11 stores information used to discriminate the phrases of an original. The region 12 stores information on the number of independent words contained in the phrases of the original. The region 13 stores information used to discriminate the phrases of a translation. The region 14 stores information on the number of independent words contained in the phrases of the translation. The region 15 stores information on numbers according to the types of the correspondences between pairs of the phrases of the original and the phrases of the translation.

The “numbers” in the region 15 of FIG. 8 indicate the number of the correspondences “bi-directional.” For example, the number “2” according to the type of the correspondence between a noun phrase 1a and a noun phrase 1b indicates that there are two words establishing the correspondence “bi-directional” between a pair of the noun phrase 1a and the noun phrase 1b.

The “numbers with brackets” in the region 15 of FIG. 8 indicate the number of the correspondences “S→T.” For example, the number “(1)” according to the type of the correspondence between a noun phrase 3a and a noun phrase 4b indicates that there is one word establishing the correspondence “S→T” between a pair of the noun phrase 3a and the noun phrase 4b.

A description will be given of FIG. 9. The correspondence table 147b has regions 21, 22, 23, 24, and 25. The region 21 stores information used to discriminate the phrases of an original. The region 22 stores information on the number of independent words contained in the phrases of the original. The region 23 stores information used to discriminate the phrases of a translation. The region 24 stores information on the number of independent words contained in the phrases of the translation. The region 25 stores information on numbers according to the types of the correspondences between the pairs of the phrases of the original and the translation. The “numbers” in the region 25 indicate the number of the correspondences “bi-directional.” The “numbers with brackets” in the region 25 indicate the number of the correspondences “S→T.”

The “numbers with ↓” in the region 25 of FIG. 9 indicate the number of the correspondences “part of S.” For example, the number “↓1” according to the correspondence between noun phrases 3c and 4d indicates that there is one word establishing the correspondence “part of S” between a pair of the noun phrases 3c and 4d.

The “numbers with →” in the region 25 of FIG. 9 indicate the number of the correspondences “part of T.” For example, the number “→1” according to the correspondence between noun phrases 6c and 5d indicates that there is one word establishing the correspondence “part of T” between a pair of the noun phrases 6c and 5d.

A description will be given of FIG. 10. The correspondence table 147c has regions 31, 32, 33, 34, and 35. The region 31 stores information used to discriminate the phrases of an original. The region 32 stores information on the number of independent words contained in the phrases of the original. The region 33 stores information used to discriminate the phrases of a translation. The region 34 stores information on the number of independent words contained in the phrases of the translation. The region 35 stores information on numbers according to the types of the correspondences between pairs of the phrases of the original and the translation. The “numbers” in the region 35 indicate the number of the correspondences “bi-directional.” The “numbers with brackets” in the region 35 indicate the number of the correspondences “S→T.” The “numbers with ↓” in the region 35 indicate the number of the correspondences “part of S.” The “numbers with →” in the region 35 indicate the number of the correspondences “part of T.”

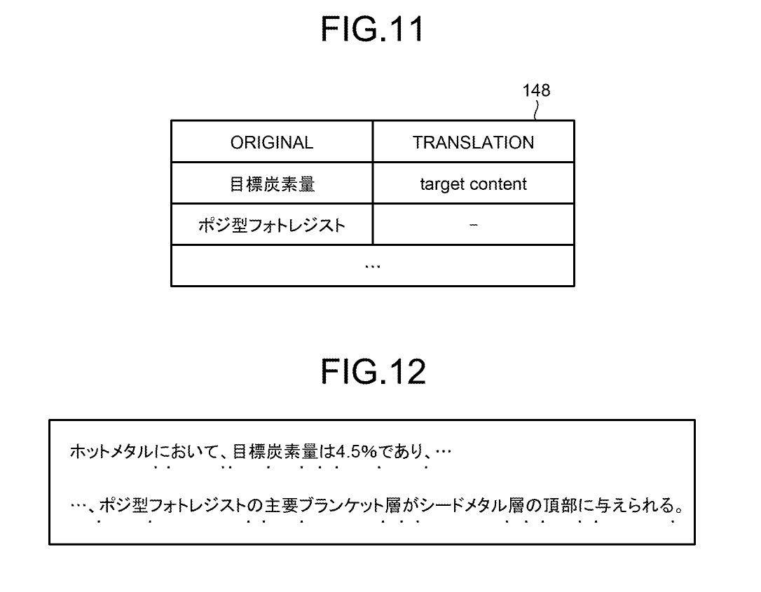

The translation missing candidate information 148 is information in which the phrases of an original and a translation are made to correspond to each other, the phrase of the translation corresponding to the phrase of the original and presumed to be a translation missing part. FIG. 11 is a diagram illustrating an example of the translation missing candidate information. As illustrated in FIG. 11, the translation missing candidate information 148 makes an original and a translation correspond to each other. For example, the original “ [symbol] ” corresponds to the translation “target content,” but the translation is presumed to have a translation missing part. In addition, it is indicated that the original “ [symbol] [symbol] ” does not have a corresponding translation.

The control section 150 has a morpheme analysis unit 151, a word correspondence analysis unit 152, a generation unit 153, an evaluation unit 154, and an output unit 155. The control section 150 corresponds to, for example, an integrated device such as an ASIC (Application Specific Integrated Circuit) and an FPGA (Field Programmable Gate Array). In addition, the control section 150 corresponds to, for example, an electronic circuit such as a CPU (Central Processing Unit) and a MPU (Micro Processing Unit).

The morpheme analysis unit 151 is a processing unit that performs morpheme analysis on the original information 143 and the translation information 144. The morpheme analysis unit 151 performs the morpheme analysis on the original information 143 to generate an original morpheme list. The morpheme analysis unit 151 performs the morpheme analysis on the translation information 144 to generate a translation morpheme list. The morpheme analysis unit 151 outputs information on the original morpheme list and the translation morpheme list to the word correspondence analysis unit 152.

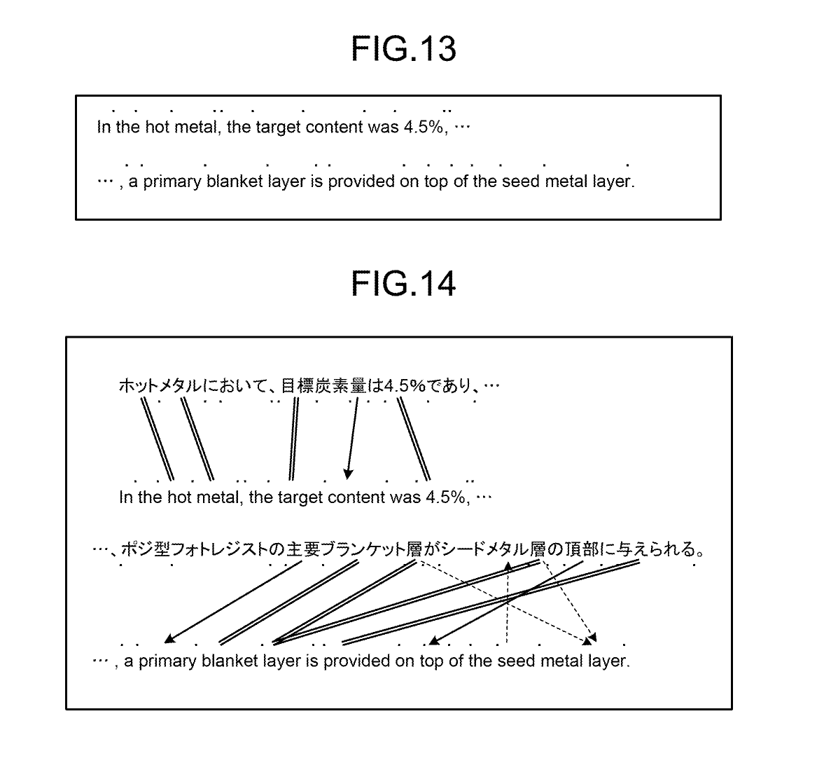

FIG. 12 is a diagram illustrating an example of the original morpheme list. FIG. 13 is a diagram illustrating an example of the translation morpheme list. The dots illustrated in FIGS. 12 and 13 indicate the breaking points between the words.

The word correspondence analysis unit 152 is a processing unit that generates the word correspondence table 145 based on the original morpheme list, the translation morpheme list, the Japanese-English bilingual dictionary information 141, and the English-Japanese bilingual dictionary information 142. For example, the word correspondence analysis unit 152 converts a word in the original morpheme list into an English word based on the Japanese-English bilingual dictionary information 141 and compares the converted English word with the word in the translation morpheme list to determine whether these words partially or fully correspond to each other. In addition, the word correspondence analysis unit 152 converts a word in the translation morpheme list into a Japanese word based on the English-Japanese bilingual dictionary information 142 and compares the converted Japanese word with the word in the original morpheme list to determine whether these words partially or fully correspond to each other. Based on the determination results, the word correspondence analysis unit 152 classifies the correspondence between the original and translation words into any of “bi-directional,” “S→T,” “T→S,” “part of S,” “part of T,” and “no correspondence.” Based on the classification result, the word correspondence analysis unit 152 registers the correspondence between the respective words in the word correspondence table 145.

FIG. 14 is a diagram for describing processing results by the word correspondence analysis unit. The character strings in the first and third rows of FIG. 14 correspond to the character strings in the original morpheme list. The character strings in the second and fourth rows of FIG. 14 correspond to the character strings in the translation morpheme list. It is indicated that the correspondences between the respective words made to correspond to each other by two lines illustrated in FIG. 14 are “bi-directional.” For example, the correspondence between the original “ [symbol] ” and the translation “hot” is “bi-directional.”

In FIG. 14, it is indicated that the correspondences between the respective words made to correspond to each other by solid lines with arrows directed from the original to the translation are “S→T.” For example, the correspondence between the original “ [symbol] ” and the translation “content” is “S→T.” Note that a description of the correspondence “T→S” will be omitted.

In FIG. 14, it is indicated that the correspondences between the respective words made to correspond to each other by dashed lines with arrows directed from the original to the translation are “part of S.” For example, the correspondence between the original “ [symbol] ” and the translation “metal layer” is “part of S.”

In FIG. 14, it is indicated that the correspondence between the respective words made to correspond to each other by a dashed line with an arrow directed from the translation to the original is “part of T.” For example, the correspondence between the original “ [symbol] ” and the translation “seed” is “part of T.”

The description of FIG. 1 will be resumed. The generation unit 153 applies a bottom-up syntax analysis rule to respective words in an original morpheme list to generate subtrees that form the combinations of respective character strings contained in an original to constitute phrases. In addition, the generation unit 153 applies the bottom-up syntax analysis rule to respective words in a translation morpheme list to generate subtrees that form the combinations of respective character strings contained in a translation to constitute phrases.

The generation unit 153 generates subtrees by applying the following rules. Note that the following rules are given only for the purpose of illustration. Although other rules are available, their descriptions will be omitted here.

Rule 1: A noun phrase is constituted of an article and a noun.

Rule 2: A verb phrase is constituted of a noun phrase and a verb phrase.

Rule 3: A verb phrase is constituted of a be-verb and a noun.

Rule 4: A noun phrase corresponds to a noun.

Rule 5: A verb phrase corresponds to a verb.

With reference to FIG. 7, a description will be given of an example of processing for applying the bottom-up syntax analysis rule by the generation unit 153. Since the combination of the be-verb “was” and the noun “4.5%” is a verb phrase according to the rule 3, the generation unit 153 regards “was 4.5%” as a subtree and categorizes the same as the “verb phrase.” In addition, since the combination of the noun phrase “content” and the verb phrase “was 4.5%” is a verb phrase according to the rule 2, the generation unit 153 regards “content was 4.5%” as a subtree and categorizes the same as the “verb phrase.” The generation unit 153 registers information according to the processing results with the application of the bottom-up syntax analysis rule in the subtree information 146.

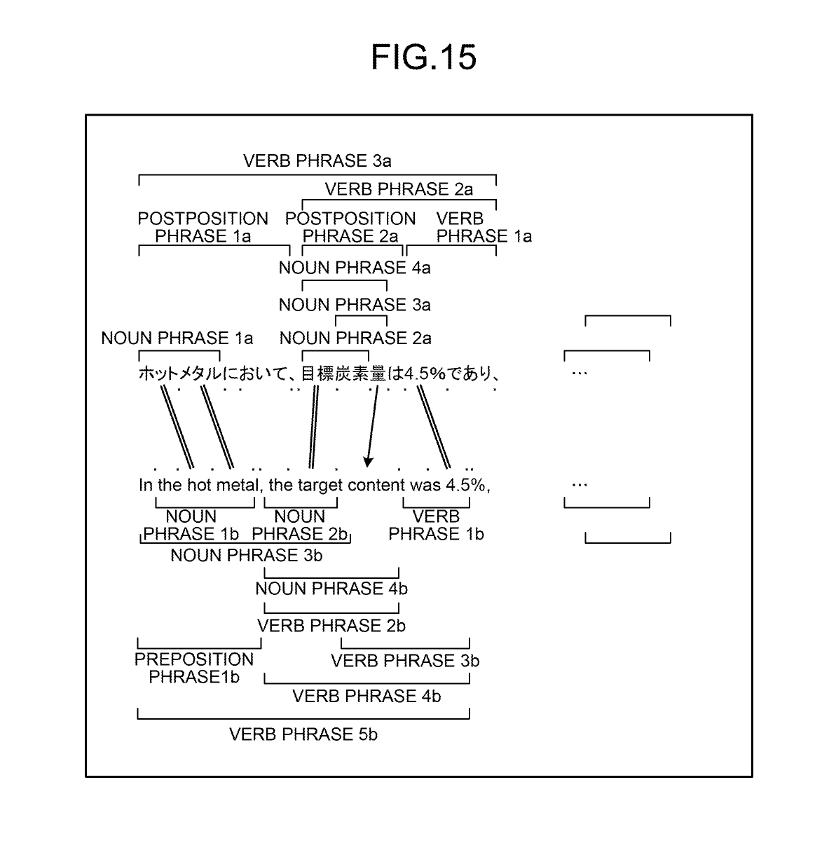

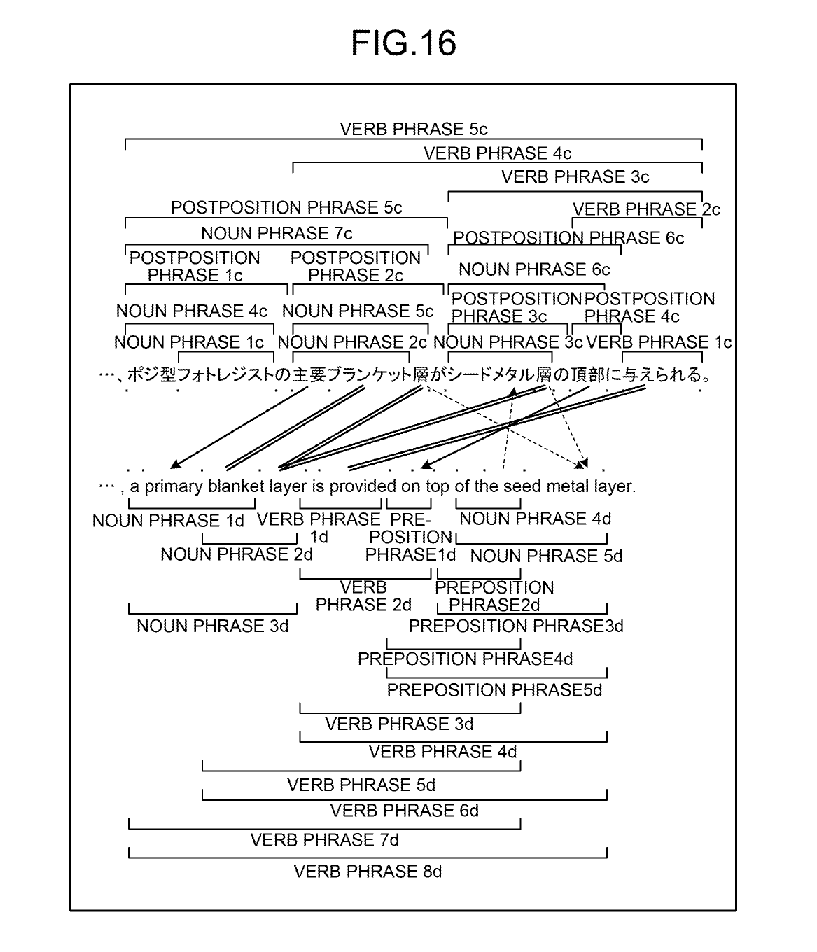

FIGS. 15 and 16 are diagrams each illustrating an example of processing results with the application of the bottom-up syntax analysis rule. FIGS. 15 and 16 also illustrate the correspondences between respective words as an example. In FIGS. 15 and 16, a character string on the upper stage corresponds to an original, and a character string on the lower stage corresponds to a translation.

A description will be given of FIG. 15. The generation unit 153 applies the bottom-up syntax analysis rule to the original to generate the subtrees of noun phrases 1a to 4a, postposition phrases 1a and 2a, and verb phrases 1a to 3a. In addition, the generation unit 153 applies the bottom-up syntax analysis rule to the translation to generate the subtrees of noun phrases 1b to 4b, a preposition phrase 1b, and verb phrases 1b to 5b.

A description will be given of FIG. 16. The generation unit 153 applies the bottom-up syntax analysis rule to the original to generate the subtrees of noun phrases 1c to 7c, postposition phrases 1c to 6c, and verb phrases 1c to 5c. In addition, the generation unit 153 applies the bottom-up syntax analysis rule to the translation to generate the subtrees of noun phrases 1d to 5d, preposition phrase 1d to 5d, and verb phrases 1d to 8d.

Next, the generation unit 153 determines the correspondences between the respective subtrees based on the word correspondence table 145 and the subtree information 146 and registers the determination results in the correspondence table 147. With reference to FIG. 15, a description will be given of the processing of the generation unit 153. For example, the two correspondences “bi-directional” exist between the noun phrases 1a and 1b. Therefore, the generation unit 153 sets “2” at the cell corresponding to the noun phrases 1a and 1b in the correspondence table 147a. The one correspondence “S→T” exists between the noun phrases 3a and 4b. Therefore, the generation unit 153 sets “(1)” at the cell corresponding to the noun phrases 3a and 4b in the correspondence table 147a.

With reference to FIG. 16, a description will be given of the processing of the generation unit 153. For example, the one correspondence “part of S” and the one correspondence “part of T” exit between the noun phrase 3c and the preposition phrase 3d. Therefore, the generation unit 153 sets “↓1” and “→1” at the cell corresponding to the noun phrase 3c and the preposition phrase 3d in the correspondence table 147b. By successively performing the above processing, the generation unit 153 successively stores the information in the correspondence table 147.

The evaluation unit 154 is a processing unit that evaluates the correspondence degree between the subtrees of an original and a translation based on the correspondence table 147. For example, the evaluation unit 154 calculates the formula (1) to obtain the correspondence degree as an evaluation value. Sw indicates the number of independent words contained in the subtree of an original. Tw indicates the number of independent words contained in the subtree of a translation. Cw indicates the sum of the number of corresponding words described in a cell corresponding to the subtrees of the original and the translation in the correspondence table 147.

(Sw−Tw)/2^{(Tw-Cw)} (1)

When the evaluation value calculated from the formula (1) is greater than or equal to a threshold, the evaluation unit 154 determines that translation missing has occurred and registers the combination of the subtrees of an original and an translation thus determined in the translation missing candidate information 148 such that they are made to correspond to each other. A description will be given of an example of calculating the evaluation value below. Note that the threshold is set at 1.

A description will be given of an example of calculating the evaluation value of the subtrees of the noun phrases 4a and 4b in FIG. 8. In this case, Sw is “3,” Tw is “2,” and Cw is “2,” and thus the evaluation value is “1.” Since the evaluation value is greater than or equal to the threshold, the evaluation unit 154 registers the combination of the noun phrases 4a and 4b in the translation missing candidate information 148. Note that the evaluation unit 154 adds together numbers of the various correspondences as equivalent numbers to calculate Cw.

A description will be given of an example of calculating the evaluation value of the subtrees of the noun phrases 7c and 3d in FIG. 9. In this case, Sw is “6,” Tw is “3,” and Cw is “3,” and thus the evaluation value is “3.” Since the evaluation value is greater than or equal to the threshold, the evaluation unit 154 registers the combination of the noun phrases 7c and 3d in the translation missing candidate information 148.

A description will be given of an example of calculating the evaluation value of the subtrees of the verb phrases 5c and 8d in FIG. 10. In this case, Sw is “10,” Tw is “7,” and Cw is “7,” and thus the evaluation value is “3.” Since the evaluation value is greater than or equal to the threshold, the evaluation unit 154 registers the combination of the verb phrases 5c and 8d in the translation missing candidate information 148.

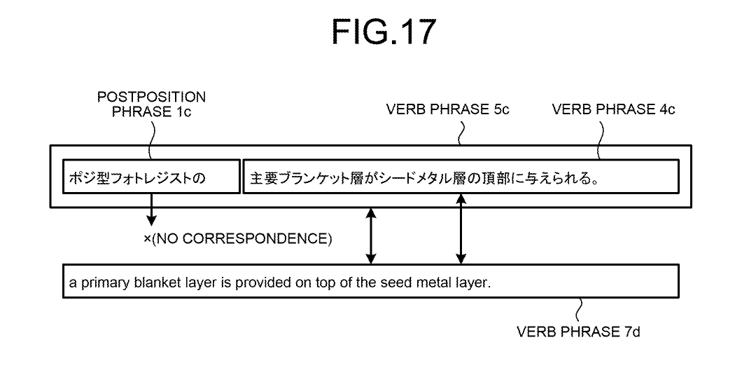

In addition, the evaluation unit 154 may evaluate the correspondences between subtrees lower than the subtrees of an original and a translation to specify expressions causing translation missing, the evaluation values of the subtrees of the original and the translation being greater than or equal to a threshold. FIG. 17 is a diagram for describing the processing of the evaluation unit.

FIG. 17 illustrates the verb phrases 5c and 7d as an example. The evaluation unit 154 divides the verb phrase 5c into the subtrees of the postposition phrase 1c and the verb phrase 4c. When the evaluation unit 154 determines the correspondences with reference to the correspondence table 147, it is found that the correspondence between the verb phrases 4c and 7d exists but the correspondence between the postposition phrase 1c and the verb phrase 7d does not exist. In this case, the evaluation unit 154 determines that the expression of the postposition phrase 1c of the verb phrase 5c as a translation missing candidate is a translation missing part. The evaluation unit 154 registers the postposition phrase 1c and the translation “blank” in the translation missing candidate information 148 so as to correspond to each other.

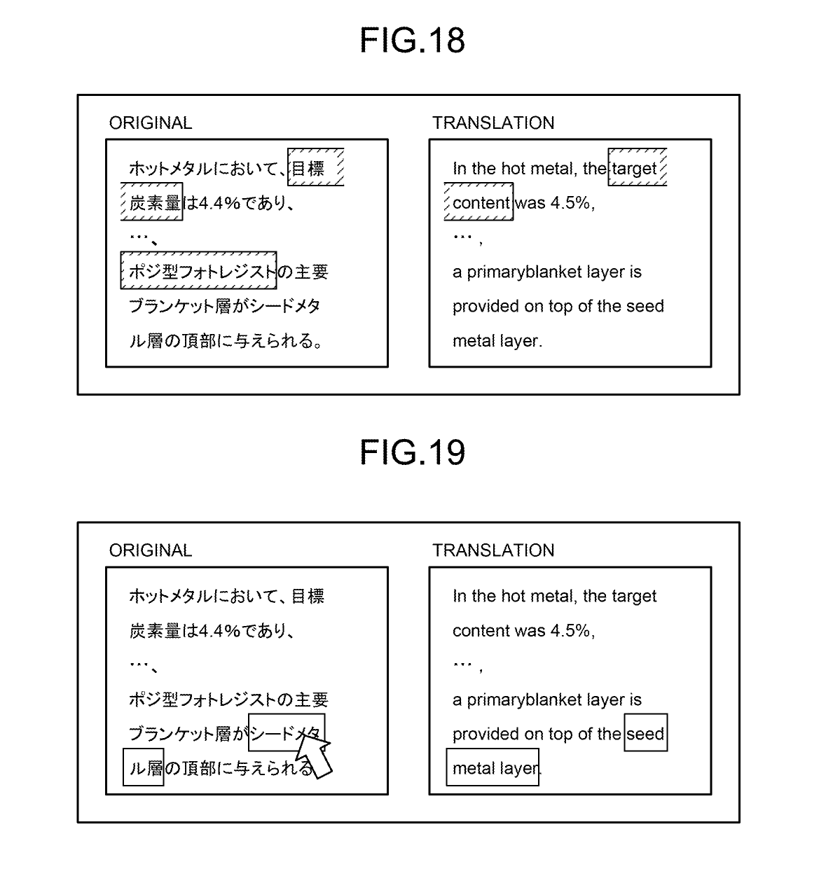

The output unit 155 displays the original information 143 and the translation information 144 on the display section 120 so as to correspond to each other. In addition, the output unit 155 highlights the expressions of an original and a translation presumed to cause translation missing based on the translation missing candidate information 148 and displays the same on the display section 120. FIG. 18 is a diagram (1) illustrating an example of a display screen. In the example illustrated in FIG. 18, the original “ [symbol] ” and the translation “target content” are highlighted and displayed. In addition, the output unit 155 may highlight and display the original “ [symbol] [symbol] ” having no corresponding translation.

Note that when an original phrase is specified by the user operating the input section 110, the output unit 155 may highlight and display a translation phrase corresponding to the specified original phrase. For example, the output unit 155 compares a specified phrase with the word correspondence table 145, the subtree information 146, and the correspondence table 147 to determine a corresponding phrase. Similarly, when a translation phrase is specified by the user operating the input section 110, the output unit 155 may highlight and display an original phrase corresponding to the specified translation phrase. FIG. 19 is a diagram (2) illustrating an example of the display screen. In the example illustrated in FIG. 19, when the original phrase “ [symbol] ” is specified, the output unit 155 highlights and displays the translation phrase “seed metal layer” corresponding to the original phrase “ [symbol] .”

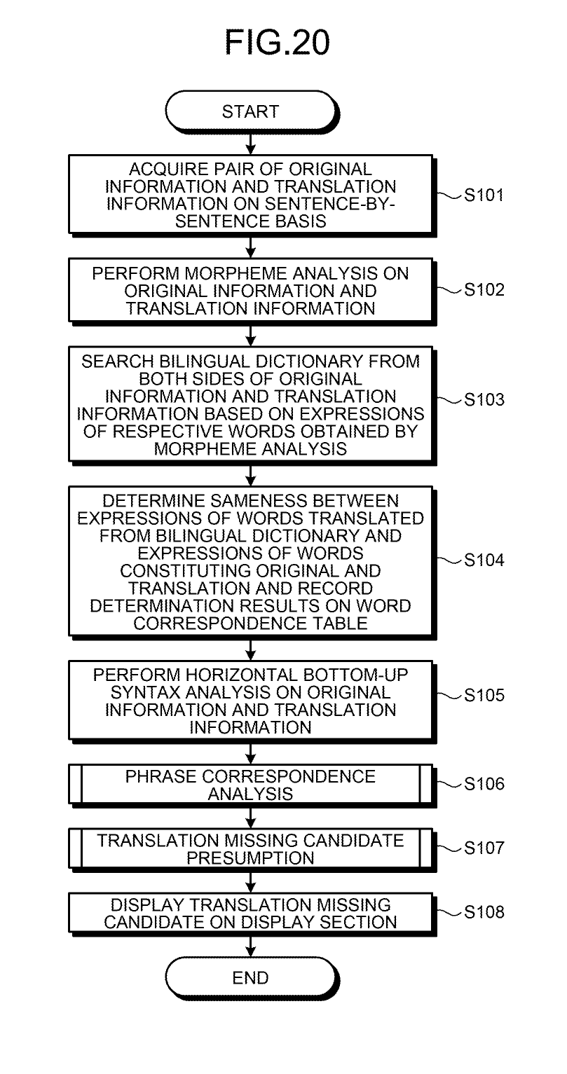

Next, a description will be given of the processing procedure of the translation support apparatus 100 according to the embodiment. FIG. 20 is a flowchart illustrating the processing procedure of the translation support apparatus according to the embodiment. The processing illustrated in FIG. 20 is performed with the acquisition of the original information 143 and the translation information 144. As illustrated in FIG. 20, the translation support apparatus 100 acquires a pair of the original information 143 and the translation information 144 on a sentence-by-sentence basis (step S101).

The translation support apparatus 100 performs morpheme analysis on the original information 143 and the translation information 144 (step S102). The translation support apparatus 100 searches a bilingual dictionary from both sides of the original information 143 and the translation information 144 based on the expressions of respective words obtained by the morpheme analysis (step S103).

The translation support apparatus 100 determines the sameness between the expressions of words translated from the bilingual dictionary and the expressions of the words constituting the original and the translation and records the determination results on the word correspondence table 145 (step S104). The translation support apparatus 100 performs horizontal bottom-up syntax analysis on the original information 143 and the translation information 144 (step S105).

The translation support apparatus 100 performs phrase correspondence analysis (step S106) and translation missing candidate presumption (step S107). The translation support apparatus 100 displays a translation missing candidate on the display section 120 (step S108).

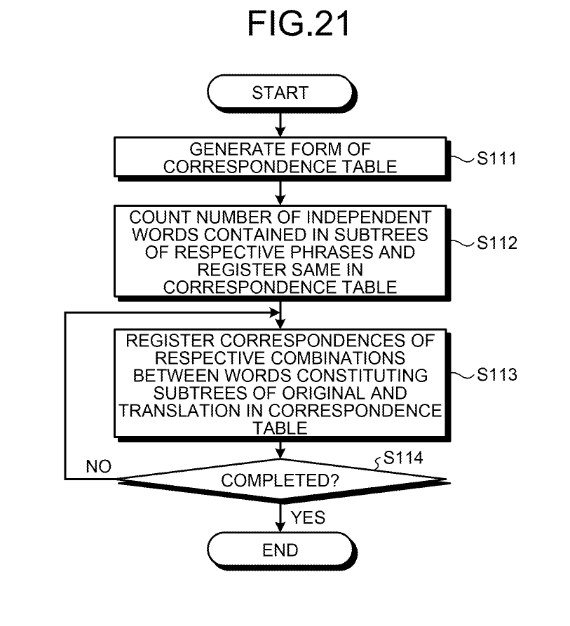

Next, a description will be given of the processing procedure of the phrase correspondence analysis illustrated in step S106 of FIG. 20. FIG. 21 is a flowchart illustrating the processing procedure of the phrase correspondence analysis. As illustrated in FIG. 21, the translation support apparatus 100 generates the form of the correspondence table 147 (step S111). The translation support apparatus 100 counts the number of independent words contained in the subtrees of respective phrases and registers the same in the correspondence table 147 (step S112).

The translation support apparatus 100 registers the correspondences of the respective combinations between words constituting the subtrees of the original and the translation in the correspondence table 147 (step S113). Upon completing the registration of the correspondences from the first to the last subtrees of the original and from the first to the last subtrees of the translation (Yes in step S114), the translation support apparatus 100 ends the phrase correspondence analysis. On the other hand, when the registration of the correspondences has not been completed (No in step S114), the translation support apparatus 100 proceeds to step S113 again.

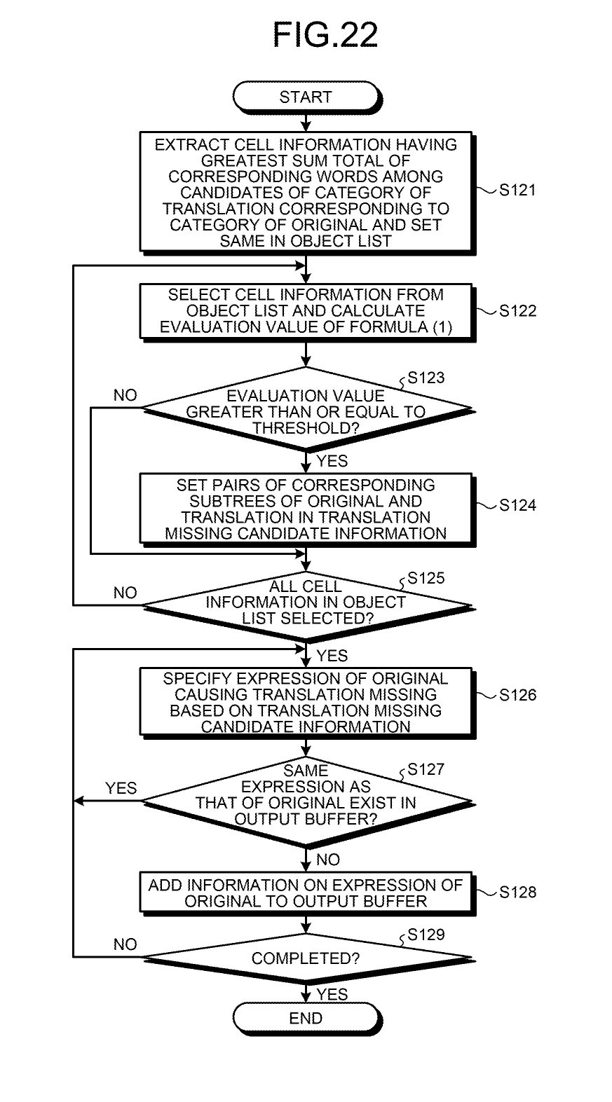

Next, a description will be given of the processing procedure of the translation missing candidate presumption illustrated in step S107 of FIG. 20. FIG. 22 is a flowchart illustrating the processing procedure of the translation missing candidate presumption. As illustrated in FIG. 22, the translation support apparatus 100 extracts cell information having the greatest sum total of corresponding words among the candidates of the category of the translation corresponding to the category of the original and sets the same in an object list (step S121). The graphic illustration of the object list is omitted.

The translation support apparatus 100 selects the cell information from the object list and calculates an evaluation value according to the formula (1) (step S122). The translation support apparatus 100 determines whether the evaluation value is greater than or equal to a threshold (step S123). When the evaluation value is less than the threshold (No in step S123), the translation support apparatus 100 proceeds to step S125.

On the other hand, when the evaluation value is greater than or equal to the threshold (Yes in step S123), the translation support apparatus 100 sets pairs of the corresponding subtrees of the original and the translation in the translation missing candidate information 148 (step S124).

The translation support apparatus 100 determines whether all the cell information in the object list have been selected (step S125). When all the cell information have not been selected (No in step S125), the translation support apparatus 100 proceeds to step S122. On the other hand, when all the cell information have been selected (Yes in step S125), the translation support apparatus 100 proceeds to step S126.

Based on the translation missing candidate information 148, the translation support apparatus 100 specifies the expression of the original causing translation missing (step S126). The translation support apparatus 100 determines whether the same expression as that of the original exists in an output buffer (step S127). When the same expression as that of the original exists in the output buffer (Yes in step S127), the translation support apparatus 100 proceeds to step S126.

On the other hand, when the same expression as that of the original does not exist in the output buffer (No in step S127), the translation support apparatus 100 adds information on the expression of the original to the output buffer (step S128). When the processing has not been completed from the first to the last cell information in the object list (No in step S129), the translation support apparatus 100 proceeds to step S126. On the other hand, when the processing has been completed (Yes in step S129), the translation support apparatus 100 ends the processing of the translation missing candidate presumption.

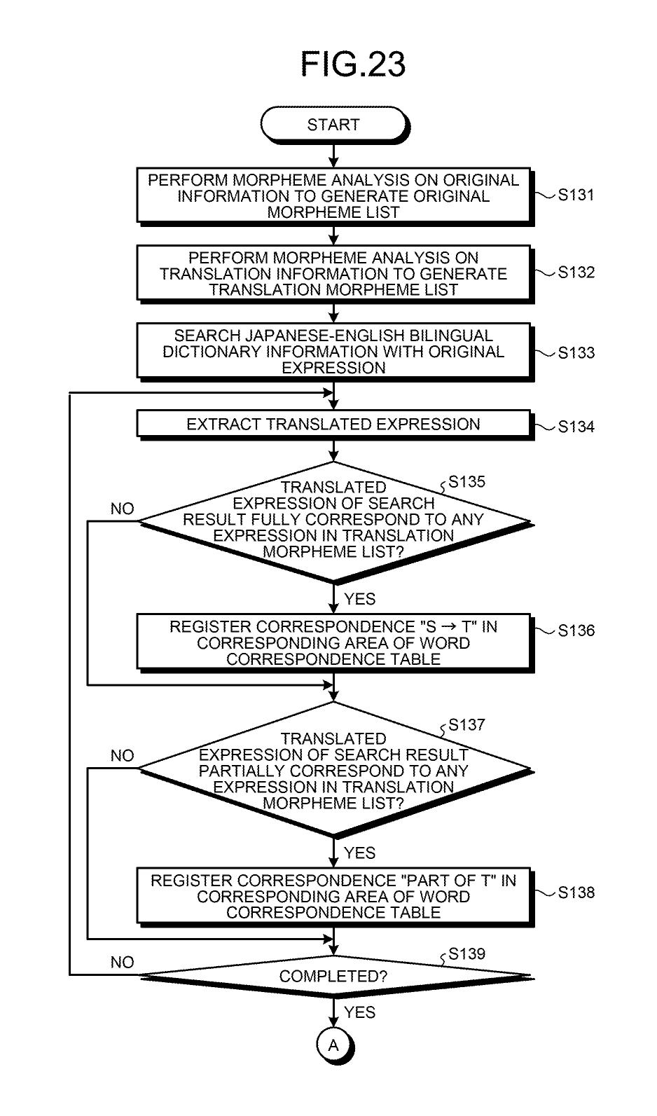

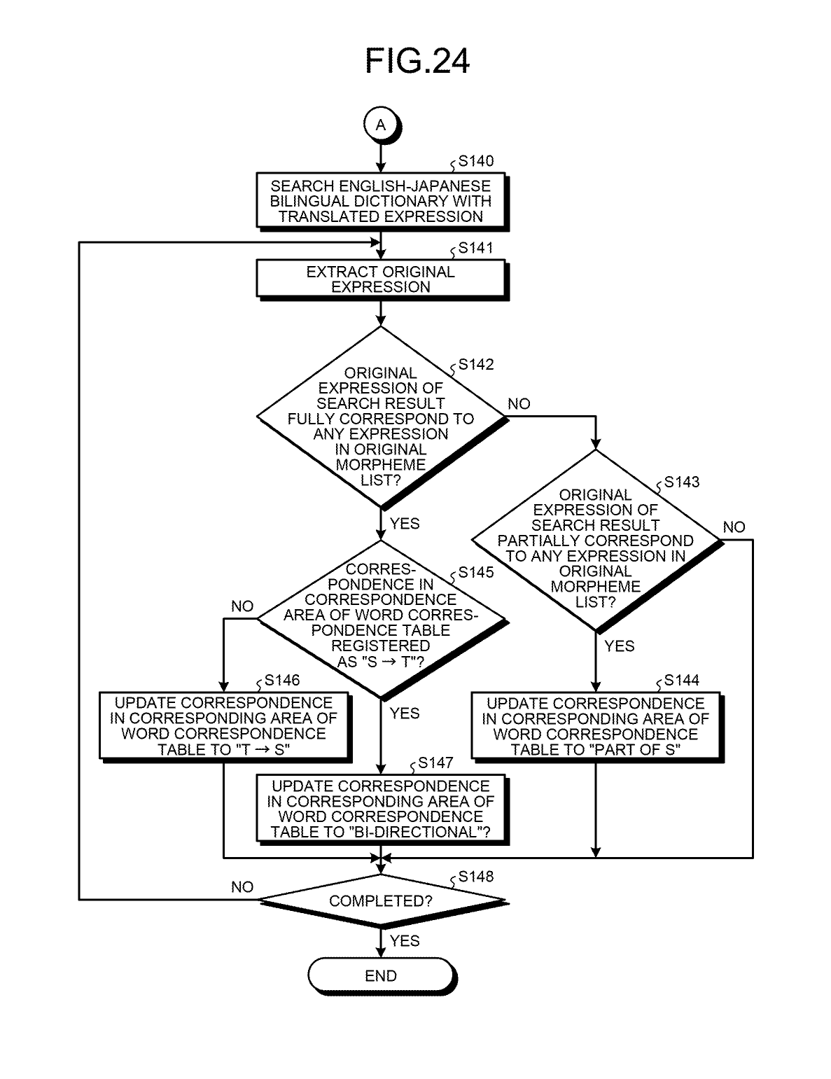

Next, a description will be given of processing for generating the word correspondence table 145 by the translation support apparatus 100. FIGS. 23 and 24 are flowcharts each illustrating a processing procedure for generating the word correspondence table. As illustrated in FIG. 23, the translation support apparatus 100 performs morpheme analysis on original information to generate an original morpheme list (step S131). The translation support apparatus 100 performs morpheme analysis on translation information to generate a translation morpheme list (step S132).

The translation support apparatus 100 searches the Japanese-English bilingual dictionary with an original expression (step S133) and extracts a translated expression (step S134). When the translated expression of the search result fully corresponds to any expression in the translation morpheme list (Yes in step S135), the translation support apparatus 100 proceeds to step S136. On the other hand, when the translated expression of the search result does not fully correspond to any expression in the translation morpheme list (No in step S135), the translation support apparatus 100 proceeds to step S137.

The translation support apparatus 100 registers the correspondence “S→T” in the corresponding area of the word correspondence table 145 (step S136) and proceeds to step S137.

When the translated expression of the search result partially corresponds to any expression in the translation morpheme list (Yes in step S137), the translation support apparatus 100 proceeds to step S138. On the other hand, when the translated expression of the search result does not partially correspond to any expression in the translation morpheme list (No in step S137), the translation support apparatus 100 proceeds to step S139.

The translation support apparatus 100 registers the correspondence “part of T” in the corresponding area of the word correspondence table 145 (step S138) and proceeds to step S139.

When the processing has not been completed from the first to the last expressions in the translation morpheme list based on the search result (No in step S139), the translation support apparatus 100 proceeds to step S134. On the other hand, when the processing has been completed (Yes in step S139), the translation support apparatus 100 proceeds to step S140 in FIG. 24.

A description will be given of FIG. 24. The translation support apparatus 100 searches the English-Japanese bilingual dictionary with a translated expression (step S140). The translation support apparatus 100 extracts an original expression (step S141). When the original expression of the search result fully corresponds to any expression in the original morpheme list (Yes in step S142), the translation support apparatus 100 proceeds to step S145. On the other hand, when the expression of the original as the search result does not fully correspond to any expression in the original morpheme list (No in step S142), the translation support apparatus 100 proceeds to step S143.

When the original expression of the search result partially corresponds to any expression in the original morpheme list (Yes in step S143), the translation support apparatus 100 updates the correspondence in the corresponding area of the word correspondence table 145 to “part of S” (step S144) and proceeds to step S148. On the other hand, when the original expression of the search result does not partially correspond to any expression in the original morpheme list (No in step S143), the translation support apparatus 100 proceeds to step S148.

When the correspondence in the correspondence area of the word correspondence table 145 has been registered as “S→T” (Yes in step S145), the translation support apparatus 100 updates the correspondence in the corresponding area of the word correspondence table 145 to “bi-directional” (step S147) and proceeds to step S148. When the correspondence in the correspondence area of the word correspondence table 145 has not been registered as “S→T” (No in step S145), the translation support apparatus 100 updates the correspondence in the corresponding area of the word correspondence table 145 to “T→S” (step S146) and proceeds to step S148.

When the processing has not been ended from the first to the last expressions in the original morpheme list based on the search result (No in step S148), the translation support apparatus 100 proceeds to step S141. On the other hand, when the processing has been completed (Yes in step S148), the translation support apparatus 100 ends the processing for generating the word correspondence table.

Next, a description will be given of the effects of the translation support apparatus 100 according to the embodiment. The translation support apparatus 100 according to the embodiment applies the bottom-up syntax analysis rule to original information and translation information to generate subtrees corresponding to the combinations of all the character strings and makes the subtrees of the original and the translation correspond to each other. Then, for each pair of the subtrees of the original and the translation, the translation support apparatus 100 evaluates a correspondence degree according to the presence or absence of the relevance between words based on a bilingual dictionary and the proximity of the number of the constituting words. Thus, according to the translation support apparatus 100, it is possible to improve accuracy in detecting translation missing.

In addition, the translation support apparatus 100 evaluates a correspondence degree based on the number of words in parallel translation relationship out of the words of the subtrees of an original and a translation and based on the difference between the number of the words of the subtrees of the original and the translation. When no translation missing occurs, there is a likelihood that the number of the words of the subtrees of the original and the translation are nearly the same and the number of words in parallel translation relationship out of the words of the subtrees of the original and the translation increases. Thus, according to the above method, it is possible to accurately detect translation missing.

Moreover, the translation support apparatus 100 evaluates the correspondences between subtrees lower than the subtrees of an original and a translation to specify expressions causing translation missing, the evaluation values of the subtrees of the original and the translation being greater than or equal to a threshold. Thus, it is possible to narrow the area of translation missing.

Furthermore, the translation support apparatus 100 highlights and outputs the expressions of an original and a translation presumed to cause translation missing. Thus, it is possible for the user to easily confirm expressions causing translation missing.

Meanwhile, the embodiment of the translation support apparatus 100 described above is an example. For example, a server apparatus may have the same function as that of the translation support apparatus 100. The server apparatus receives original information and translation information from a terminal apparatus connected via a network and evaluates a translation missing part in the same manner as the translation support apparatus 100. Then, the server apparatus may notify the terminal apparatus of the evaluation result via the network.

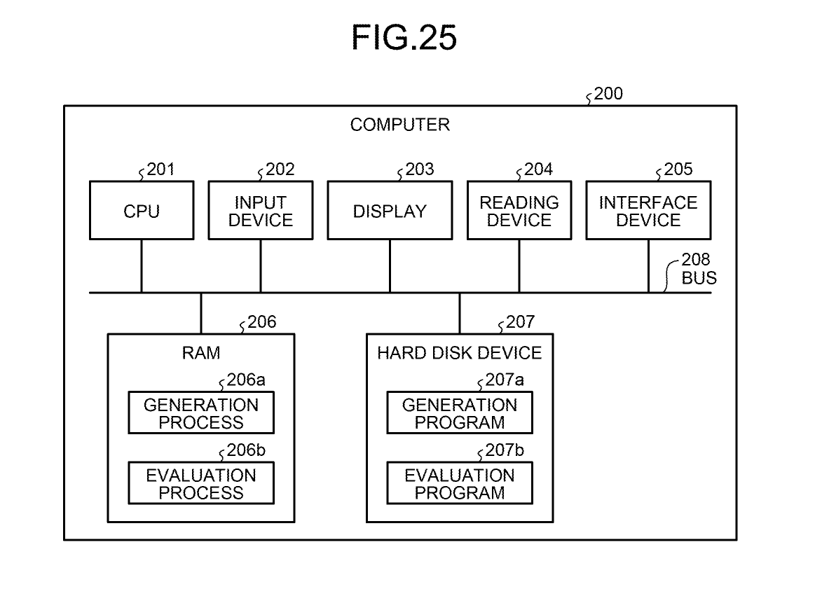

Next, a description will be given of an example of a computer that performs a translation support program to realize the same function as that of the translation support apparatus described in the above embodiment. FIG. 25 is a diagram illustrating an example of the computer that performs the translation support program.

As illustrated in FIG. 25, a computer 200 has a CPU 201 that performs various calculation processing, an input device 202 that receives the input of data from the user, and a display 203. In addition, the computer 200 has a reading apparatus 204 that reads a program or the like from a storage medium and an interface apparatus 205 that sends and receives data to and from other computers via a network. Moreover, the computer 200 has a RAM 206 that temporarily stores various information and a hard disk device 207. Further, each of the devices 201 to 207 is connected to a bus 208.

The hard disk device 207 has a generation program 207a and an evaluation program 207b. The CPU 201 reads each of the programs 207a and 207b and develops the same into the RAM 206.

The generation program 207a functions as a generation process 206a. The evaluation program 207b functions as an evaluation process 206b.

For example, the generation process 206a corresponds to the generation unit 153. The evaluation process 206b corresponds to the evaluation unit 154.

Note that each of the programs 207a, 207b is not necessarily stored in the hard disk device 207 in advance. For example, each of the programs is stored in a “portable physical medium” such as a flexible disk (FD), a CD-ROM, a DVD disk, a magnetic optical disk, and an IC card, each of which is to be inserted in the computer 200. Further, the computer 200 may read each of the programs 207a and 207b from such a medium to perform the same.

According to an embodiment of the present invention, it is possible to produce the effect of detecting translation missing candidates.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A translation support apparatus comprising:
a memory; and
a processor coupled to the memory, wherein the processor executes a process comprising:
generating a plurality of first subtrees and a plurality of second subtrees, by applying a bottom-up syntax analysis rule to an original and a translation, the first subtrees forming combinations of respective character strings contained in the original to constitute phrases, the second subtrees forming combinations of respective character strings contained in the translation to constitute phrases;
making the plurality of first and second subtrees correspond to each other; and
evaluating for each pair of the corresponding first and second subtrees a correspondence degree according to presence or absence of relevance between words based on a bilingual dictionary and proximity of the number of the constituting words.

2. The translation support apparatus according to claim 1, wherein the evaluating calculates an evaluation value used to evaluate the correspondence degree based on the number of the words in parallel translation relationship out of the words of the first and second subtrees and based on a difference between the number of the words of the first and second subtrees.

3. The translation support apparatus according to claim 2, wherein, when the evaluation value is greater than or equal to a threshold, the evaluating evaluates phrases of third subtrees having no correspondence with fourth subtrees as being translation missing parts based on correspondences between the third subtrees lower than the first subtrees and the fourth subtrees lower than the second subtrees, the evaluation value of the first and second subtrees being greater than or equal to the threshold.

4. The translation support apparatus according to claim 1, wherein the process further comprises highlighting and outputting expressions of the original and the translation presumed to cause the translation missing based on the correspondence degree.

5. A translation support system having a terminal apparatus and a translation support apparatus, the translation support apparatus comprising:
a memory; and
a processor coupled to the memory, wherein the processor executes a process comprising:
generating a plurality of first subtrees and a plurality of second subtrees, by applying a bottom-up syntax analysis rule to an original and a translation, the first subtrees forming combinations of respective character strings contained in the original to constitute phrases, the second subtrees forming combinations of respective character strings contained in the translation to constitute phrases;
making the plurality of first and second subtrees correspond to each other; and
evaluating for each pair of the corresponding first and second subtrees a correspondence degree according to presence or absence of relevance between words based on a bilingual dictionary and proximity of the number of the constituting words.

6. The translation support system according to claim 5, wherein the evaluating calculates an evaluation value used to evaluate the correspondence degree based on the number of the words in parallel translation relationship out of the words of the first and second subtrees and based on a difference between the number of the words of the first and second subtrees.

7. The translation support system according to claim 6, wherein, when the evaluation value is greater than or equal to a threshold, the evaluating evaluates phrases of third subtrees having no correspondence with fourth subtrees as being translation missing parts based on correspondences between the third subtrees lower than the first subtrees and the fourth subtrees lower than the second subtrees, the evaluation value of the first and second subtrees being greater than or equal to the threshold.

8. The translation support system according to claim 5, wherein the process further comprises highlighting and outputting expressions of the original and the translation presumed to cause the translation missing based on the correspondence degree.

9. A computer-readable recording medium having stored therein a program for causing a computer to execute a translation support process comprising:
generating a plurality of first subtrees and a plurality of second subtrees, by applying a bottom-up syntax analysis rule to an original and a translation, the first subtrees forming combinations of respective character strings contained in the original to constitute phrases, the second subtrees forming combinations of respective character strings contained in the translation to constitute phrases;
making the plurality of first and second subtrees correspond to each other; and
evaluating for each pair of the corresponding first and second subtrees a correspondence degree according to presence or absence of relevance between words based on a bilingual dictionary and proximity of the number of the constituting words.

10. The computer-readable recording medium according to claim 9, wherein the evaluating calculates an evaluation value used to evaluate the correspondence degree based on the number of the words in parallel translation relationship out of the words of the first and second subtrees and based on a difference between the number of the words of the first and second subtrees.

11. The computer-readable recording medium according to claim 10, wherein, when the evaluation value is greater than or equal to a threshold, the evaluating evaluates phrases of third subtrees having no correspondence with fourth subtrees as being translation missing parts based on correspondences between the third subtrees lower than the first subtrees and the fourth subtrees lower than the second subtrees, the evaluation value of the first and second subtrees being greater than or equal to the threshold.

12. The computer-readable recording medium according to claim 9, the process further comprises highlighting and outputting expressions of the original and the translation presumed to cause the translation missing based on the correspondence degree.
